(19) United States
(12) Patent Application Publication
(10) Pub. No.: US 2011/0089060 A1
(43) Pub. Date: Apr. 21, 2011

(54) Closet clothing inventory system

(76) Inventor: SHARI L. PEYSER, MELVILLE, NY (US)

(21) Appl. No.: 12/803,435

(22) Filed: Jun. 28, 2010

Related U.S. Application Data
(60) Provisional application No. 61/279,031, filed on Oct. 15, 2009.

(51) Int. Cl. B65D 85/18; G09F 3/00

(52) U.S. Cl. 206/278; 40/322

(57) ABSTRACT

A clothing tracking device is provided having a substantially rectangular body made of a rigid sheet material and equipped with a reinforced opening configured and positioned on the rigid sheet to allow a garment hanger to fit within and cause the substantially rectangular body to lie in such a way as not to interfere with or cause damage to a garment hung on said hanger. The rigid sheet material having a plurality of pockets formed from a transparent material affixed thereto. Each pocket having three sides completely affixed to the rigid sheet material and one side at least partially unfixed to the rigid sheet material to form pockets. At least one note card configured to fit within the pocket having a recording area adapted for recording date, event, and remarks about when the clothing was worn, cleaned or purchased.

### CROSS-REFERENCE TO RELATED APPLICATION

This application is a non-provisional application and claims benefit to provisional application having the Ser. No. 61/279,031 filed Oct. 16, 2009, the disclosure of which is incorporated herein by reference in is entirety.

### FIELD OF THE INVENTION

This invention relates generally to the field of clothing inventory data devices and more specifically to a system for recording information on the use of articles of apparel.

### BACKGROUND OF THE INVENTION

One old age adage is to “dress for success.” In today's world, it is a challenge for a working professional to dress for success without having an elaborate wardrobe that is often expensive to obtain as well as expensive to maintain. A wardrobe that is often much too expensive for the ordinary working professional to have and maintain. However, one way to give the appearance of an extensive wardrobe and to better maintain the clothes already in one's wardrobe is to properly manage the use, cleaning and presentation of one's clothing in the public eye.

Repeated use of the same articles of clothing in multiple appearances, or single badly matched combinations thereof, can damage the wearer's social or professional image. Although this may be mitigated by possession of extensive wardrobes, as stated above this type of extensive wardrobe may be prohibitively expensive. Moreover, undesirable chance repetitions may occur no matter how extensive the contents of one's clothes closet.

Short of discarding each piece of apparel immediately after the first time it is worn, the only way to prevent undesirable repetitions before the same clientele or observers is to keep a record of usage for each piece of clothing. Further, to save time and to prevent badly conceived last minute combinations of color, style, cloth or other characteristics, advance planning is a desirable preventive measure. Still further the frequency in which clothing is cleaned can reduce the freshness and newness of the clothing thereby limiting the life of one's clothing. Thus, maintaining a schedule for cleaning clothes can go a long way in keeping one's wardrobe from looking worn and old.

A clothing tag that allows one to inscribe when, where and with what the article of clothing was worn that attaches to a clothing hanger would essentially expand one's wardrobe in the public eye without actually purchasing additional items for one's wardrobe on a daily basis. In addition, scheduling when an article of clothing is to be cleaned also extends the life of one's wardrobe. The clothing tag can be attached to a garment hanger so that it is easily viewable and the inscribable surface protected so that ink, marker, or even pencil does not transfer to the garment of the hanger in a crowded closet.

The present invention provides a convenient system for recording information about garments in a wardrobe including apparel combinations, to which clients the garments were worn, cleaning schedules, as well as other remarks necessary to maintain a wardrobe.

### DESCRIPTION OF THE PRIOR ART

U.S. Pat. No. 5,423,139 teaches a combination care and inventory label employing a detachable tag with fixed data in text and machine-readable code. It is not intended for nor easily adapted to manual record keeping or data entry.

U.S. Pat. No. 6,035,570 teaches a tracking device for attaching to clothing and/or clothing accessories, comprising a rectangular piece of sheet material holed and scored for mounting it with or on clothing. As claimed, its shape and design provide minimal space for recording repeated or columnar data, and it does not have significant space for advertising copy. In addition, ink used to write on the limited space remains uncovered and can very easily transfer to the garment to which the sheet of material is used to record data about.

U.S. Pat. No. 3,124,284 to Column discloses a garment wear recorder by way of a paper blank folded over a hanger, wrapping over the upper portion of the hanger. The paper blank has an aperture and tabs, which can be folded one at a time when the garment is worn. The number of folded tabs keeps tally of garment usage. This folding process is destructive to the paper blank. When all the available fold tabs on the paper blank are used, garment usage can no longer be recorded, therefore when the garment usage is greater than the number of fold tabs available on the paper blank, the recording means is ineffective. The blank paper merely allows tallying of the number of times a garment is worn, it does not record the date last cleaned, and date last used, and is disposed to ineffectiveness if the garment's use exceeds the number of fold tabs available. Furthermore, the paper blank used in the '284 patented device is not moisture resistant and is subsequently vulnerable to water damage which will cause the ink used to record the data on the card to stain and possible ruin the garment on the hanger to which it is attached.

U.S. Pat. No. 7,334,359 to Palmer discloses a machine for recording or assigning the use of articles of apparel having a sheet of stiff material, perforated and folded over the hook of a hanger, and having one or more substantially flat surfaces upon which notes, assignments, usage advertisements, or other data maybe recorded. However, the surfaces where notes can be taken are not covered and facilitate the transfer of ink or pencil marks to the garment thereby destroying the garments.

U.S. Pat. No. 1,785,948 teaches an integrated hanger and display device specifically for use in advertising. This device comprises one surface for display of advertising information. Being presented for the sole purpose of advertising, it is configured in a manner more suited for artistic or graphic displays than for record keeping. As designed and claimed the device backside remains unavailable for record data, thus further limiting its usefulness for record keeping. With no useful function except advertising, the user/customer has little incentive to retain or preserve the device and its associated advertising information.

There remains a need in the art for a low cost, easy to manufacture, moisture resistant, Closet Cards™ system that can easily be affixed to a hanger so as to provide a surface where the user can quickly write information on a note card regarding the article of clothing hung on the hanger while preventing ink, marker and/or pencil used to write on the note card from transferring from the card to the garment. Information that the user can write on the Closet Cards™ that maybe useful may include 1) the date the article of clothing was last cleaned; 2) the date it was last worn; and 3) the number of times the article of clothing had been worn subsequent to the last washing or dry-cleaning and 4) whichever occasions where the garment has been worn (various locations, events, meetings, parties, office, daily work location, etc.) and/or persons have seen the garment being worn (friends, co-workers, colleagues, clients, family, community, etc.).

The present invention is directed to an improved low cost, easy to manufacture, moisture resistant, covered Closet Cards™ system that can easily be affixed to a hanger so as to provide a surface where the user can quickly write information on the note card regarding the article of clothing hung on the hanger while preventing ink, pencil or marker used to write on the card from transferring from the card to the garment that overcomes the problems with existing closet organizing cards.

The present invention is further described below in the figures and description thereof.

### SUMMARY OF THE INVENTION

An object of the present invention is to provide a clothing-tracking device comprising a substantially rectangular body made of a rigid sheet material having a reinforced opening in the rigid sheet material. The opening can be in any shape as long as it is large enough to accommodate the insertion of the hanging portion of a garment hanger. The opening is to be positioned on the rigid sheet material so as to cause the substantially rectangular body to lie in such a way as not to interfere with or cause damage to a garment hung on the garment hanger in which it is hung. The garment-tracking device of the present invention is also configured to have a plurality of pockets formed in the body of the device and is at least partially covered with a transparent material attached to the rigid sheet material of the present invention. In the alternative the pockets/pouches can be made from transparent material and affixed to the body of the device. For the purposes of the present invention, the terms pocket, pouch and sleeve are used interchangeable.

The pockets having three sides completely affixed to the rigid sheet material and one side at least partially unfixed to the rigid sheet material in order to form a pocket that fits at least one note card of the present invention. The note cards having a recording area adapted for recording date, event, and remarks of an occasion wherein the garment placed on the hanger was worn. The transparent material of the pocket is specifically designed to shield the garment being hung on the hanger from any incidental transfer of ink, marker or pencil marks from the note cards onto the garment.

Another object of the present invention is to provide a clothing-tracking device comprising a substantially rectangular body made of a rigid sheet material having a reinforced opening in the rigid sheet material that is configured to hang on a hanger. As with the embodiment described above, the reinforced opening is configured so as to cause the substantially rectangular body to lie in such a way as not to interfere with or cause damage to a garment hung on the hanger or garments adjacent to one another, i.e., hanging next to each other in a closet. The clothing-tracking device of the present invention also has a plurality of pockets formed from or covered by a transparent material on the rigid sheet material. The plurality of pockets of the present invention having at least three sides of the four sides at least partially fixed to the rigid sheet material. Two of the opposing sides are configured to form a track and the third side positioned between the two opposing sides is configured to allow at least a portion of the note card to travel along a track so that the note card to be extended out of the pocket. Once the note card is extended out of the pocket, a person can either view the information written or write additional notes thereon. The note card is then slid back into the pocket so as to protect the hanging garment from getting any ink or pencil marks transferred to them.

Yet another object of the present invention is to provide a kit comprising multiple clothing tracking devices, extra note cards, a schedule, and labels that can be used to track the wearing and pairing of items of clothing.

Still yet another object of the present invention is directed to a garment bag having the clothing-tracking device of the present invention temporally affixed to the garment bag so that it can be removed and hung on a hanger at a later time and used in accordance with the objectives of the present invention. In the alternative, the clothing-tracking device of the present invention can be affixed permanently so that it can be viewed as the garment bag is moved along a hanger in a closet. It is also within the scope of the present invention that the garment bags have the clothing-tracking device of the present invention affixed in such a way that it is already attached to the hanger provided with the garment bag so that it can be used in accordance with the objective of the present invention.

The note cards used in the present invention are configured to fit substantially within the pocket and may be fitted with a tab that extends out of the pocket so that the note cards can be slid in and out of the transplant sleeve easily. The note cards can be color-coded and/or equipped with lined recording areas for recording notes and dates. In addition, either the body of the Closet Card™ or the note card can be equipped with a Radio Frequency Identification Device (RFID), Uniform Packing Codes (UPC) or bar codes for scanning to keep track of the garments that the Closet Card™ is designed to track. The body of the Closet Card™ can also have advertisement logos, designs and/or indicia on the front and back of the body. Additional pockets to hold receipts of purchase, extra buttons and/or thread may also be added. RFID, UPC or bar codes may be developed for use with electronic information gathering devices, including cell phones, non-cell applications, databases, portable data appliances (PDAs), so that information can be managed and manipulated on personal computers and/or cellular telephones.

Another object of this invention is to provide a clothing tracking system that has a note pad covered by a plastic sleeve in order to put notes about the garment hanging on the hanger. The note pad can be equipped with a slot for holding a pen or pencil for writing on the note card so that the user will not have to search for a writing instrument when picking which outfit to wear on a particular day.

A method of using the clothing-tracking device of the present invention in accordance with the objectives of the present invention is also provided.

These, together with other objects and advantages which will become subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a prospective front view of the garment-tracking device according to the present invention.

FIG. 2 is a prospective front view of a different configuration of the garment-tracking device shown in FIG. 1 of the present invention.

FIG. 3 is a prospective front view of the garment-tracking device with a note card track for the note card to travel upwards of the present invention.

FIG. 4 is a prospective front view of the garment-tracking device with a note card track for the note card to travel sideways of the present invention.

FIG. 5 is a kit of the present invention.

FIG. 6 is a Closet Card™ and sticker system of the present invention.

FIG. 7 is a prospective front view of the garment-tracking device shown in FIG. 1 of the present invention in the open-book configuration.

FIG. 8 is a prospective front view of the Closet Cards™ of the present invention affixed to a garment bag.

### DETAILED DESCRIPTION OF THE PRESENT INVENTION

Many people, particularly those working in the professions, hospitality industry, corporate, service, business and sales, must be appropriately dressed for social or business occasions in order to create a desirable image and social impression to clients, acquaintances and other people met under such occasions. This is particularly important for repeating business or social functions to which the same people may always attend. Repeated wearing of the same clothes to such business or social functions would inherently create the impression of lack of attention to detail, failure to achieve success and lack of resources that may be detrimental to the personal image. Such undesirable happening may be avoided by having a large wardrobe; however, in most cases, the cost of acquiring a large wardrobe is economically infeasible. Even for those having a large wardrobe, there is still the potential that same clothes may be unknowingly worn to the same functions due to the lack of means of tracking what has been worn previously to such various occasions. The present invention aids in maintaining an image of an individual by-providing a convenient way to take notes on which clothing items were worn to which client/event and when.

The present invention is directed to clothing tracking device comprising a body made of a rigid sheet material having a reinforced opening therein. The reinforced opening can be in the any shape as long as it is large enough to accommodate the insertion of the hanging portion of a garment hanger. The edges of the rectangular body are rounded and smooth so prevent unwanted interaction with the material of the garment hanging on the hanger. The reinforced opening for the hanger is positioned on the rigid sheet material so as to cause the substantially rectangular body to lie in such a way as not to interfere with or cause damage to a garment hanging on the garment hanger. The clothing-tracking device of the present invention is also configured to have a plurality of sleeves/pouches formed from a transparent material attached to the rigid sheet material of the present invention.

In one embodiment of the present invention, the sleeves/pouches are configured to have three sides completely affixed to the rigid sheet material and one side at least partially unfixed to the rigid sheet material in order to form a pocket that fits at least one note card of the present invention. (As described below in FIGS. 25-26 four sides can be affixed and the pocket formed can be accessed by slits as described in these figures) The note cards having a recording area adapted for recording date, events, and remarks about where/when the garment placed on the hanger was worn. The transparent material of the sleeve/pouch is specifically designed to shield the garment being hung on the hanger from and incidental transfer of ink, marker or pencil marks from the note cards onto the garment.

The shape of the rigid card can be rectangular, square, triangular or polygonal, or any other shape as long as the edges are rounded off or smooth so as to prevent snagging of the Closet Cards™ on the garment. Particular shapes include the shape of a coat, a blouse, animals, landmarks or company symbols for those Closet Cards™ used as advertisement as well.

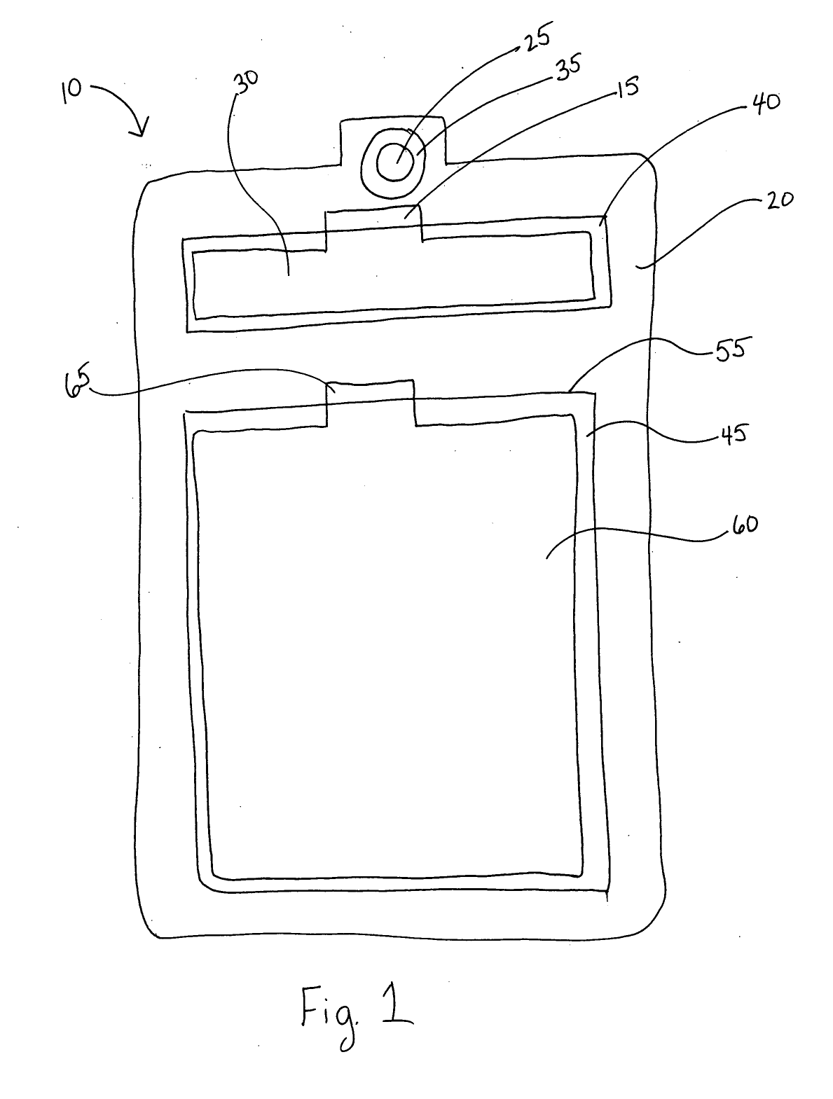

The present invention is described with reference to the drawings, wherein like reference numerals designate corresponding parts in the several views. In FIG. 1, the tracking device 10 according to the present invention has a body 20, which is made of a sheet material such as plastics or stiff paper or laminated stiff paper. The body 20 may be generally rectangular in shape; however, it will be appreciated by those skilled in the art that the present invention may have other shapes such as square, circular, drawing shapes or figures in a variety of colors. For particular garments like gowns and tuxedos, the Closet Cards™ can be the shape of a gown or tuxedo or other garment to which it is to be used. A rectangular shape is shown for illustration purposes and has rounded edges to prevent damage to the garment. An opening 25 is formed in the body 20 such that the device 10 may be attached to a garment hanger. The opening 25 is reinforced around its edges with a reinforcing material 35 such that the device 10 can withstand the normal handling of the garment without accidental tearing away from the hanger.

The body 20 is equipped with at least two plastic sleeves 40 and 45. The first sleeve 40 is positioned closed to the top of the body 20 and is smaller than the second sleeve 45 positioned below it. The first sleeve 40 is designed to fit a small note card 30 that can be inscribed with the name of the garment so that should the note card become dislodged from the hanger it can still be properly identified. The plastic sleeve 40 is predominately transparent and is designed to protect the garment from ink/pencil accidentally being transferred to the garment from the note card. The plastic can also be treated and/or tinted so as to prevent the note card from yellowing from oxidation or sunlight.

Below the first sleeve 40 is the second sleeve 45 that is much larger in size. The second sleeve 45 is at least partially attached to the rigid stock body on three sides having the top 55 open and configured to receive a note card 60. The note card 60 can be blank or can have permanent lines/columns drawn on the note card 60 so as to facilitate writing information concerning the place, date and last time cleaned in the proper place. The note card 60 can then be slide into the second transparent plastic sleeve so that the ink/pencil used to take notes is shielded from the garment. Both the first note card 30 and the second note card 60 can be equipped with a tab 15 and 65 to facilitate the lifting of the note cards out of the plastic sleeves 40 and 45.

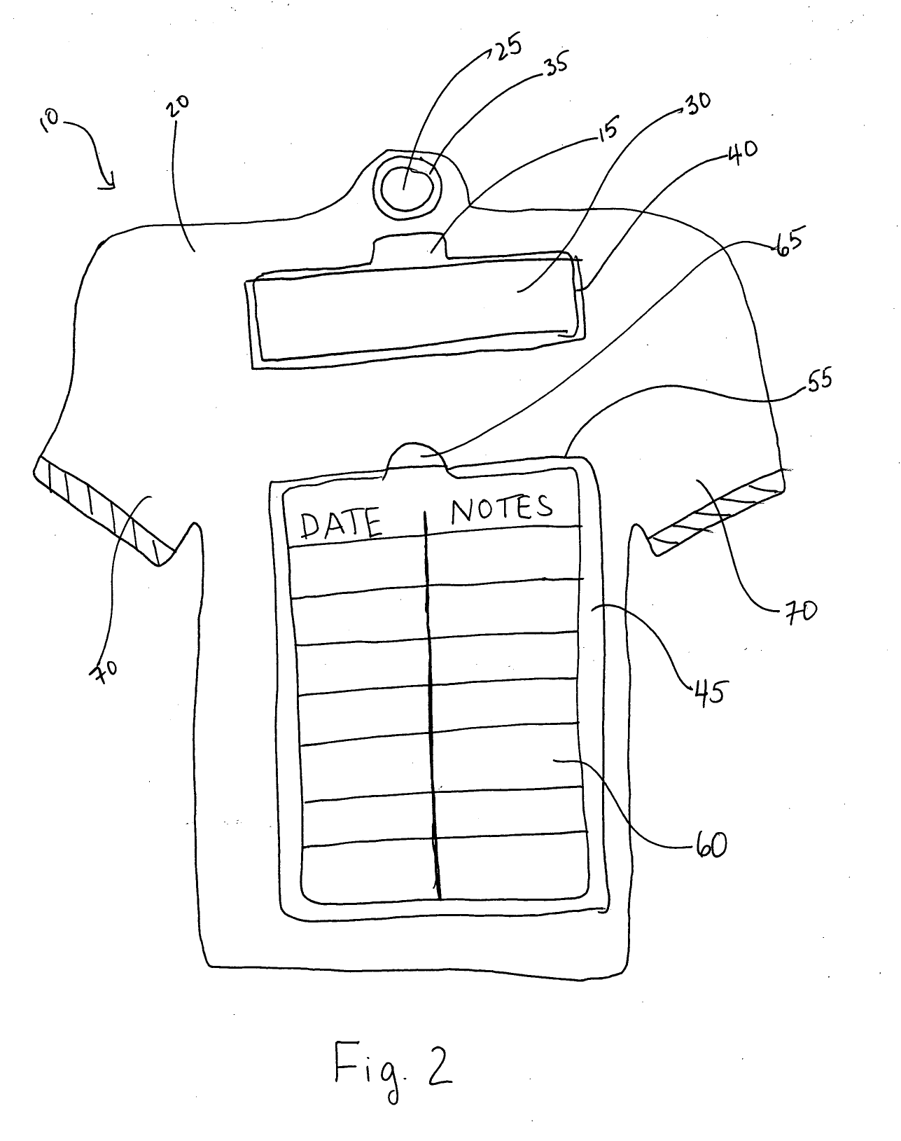

FIG. 2 shows a different configuration (a sweater) of the tracking device 10 according to the present invention. In this configuration, portions of the body 20 are configured as sweater sleeves 70 that serve as decoration or can be used for writing information. As with the configuration of the tracking device 10 according to the present invention shown in FIG. 1, the opening 25 is reinforced 35 so as to prevent accidental tearing away from the hanger. The reinforcement used can be plastic, fabric, upholstered stock, suede, leather, galvanized metal or manmade materials. If metal is used it must be coated so as to prevent rusting and damaging of the garments. The rests of the parts of FIG. 2 correspond to the parts of FIG. 1 above and serve the same functions.

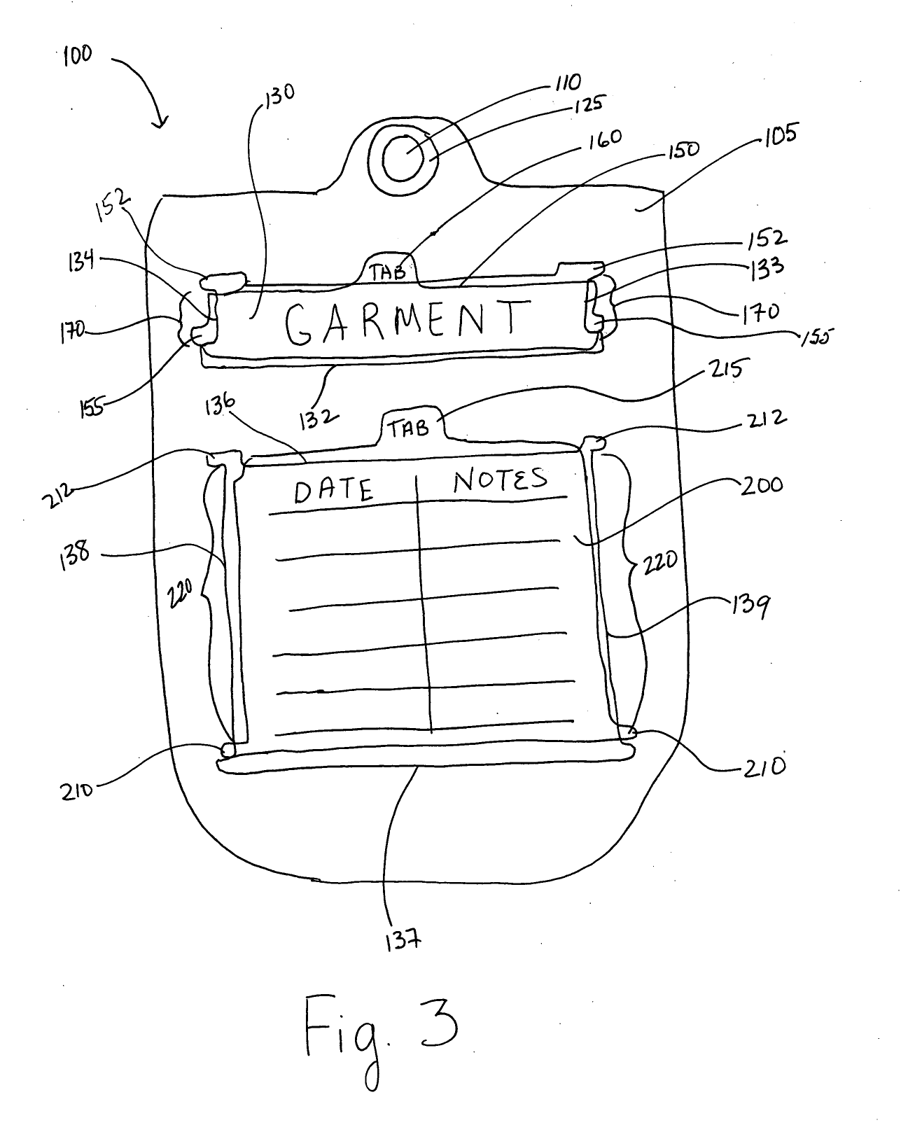

FIG. 3 shows a different configuration of the tracking device 10 shown in FIGS. 1 and 2. In FIG. 3, the tracking device 100 according to the present invention has a body 105 which is made of a sheet material such as plastic, rigid paper, laminated paper, fabric, upholstered stock, suede, leather, galvanized metal or manmade materials. If metal is used it must be coated so as to prevent rusting and damaging of the garments. The body 105 may be generally rectangular in shape with rounded corners. As with the embodiments shown in FIGS. 1 and 2, it will be appreciated by those skilled in the art that it may have other shapes such as square, circular, various animal/clothing shapes or figures and can be in a variety of colors. An opening 110 is formed in the body 105 at the top portion so that the device 100 may be attached to a garment hanger. The opening 110 is reinforced around its edges with a reinforcing material 125 to prevent accidental tearing away from the hanger.

The body 105 of the Closet Cards™ is equipped with at least two plastic sleeves 130 and 135. The first sleeve 130 is positioned close to the top of the body 105 and is smaller than the second sleeve 135 positioned below it. The first sleeve 130 is designed to fit a small note card 150 that can be inscribed with the name of the garment. This is important in identifying the garment in which the closet card is associated with should the note card 150 become dislodged from the hanger. In other words, it is important to provide the name of the garment that the card is associated with so that the Closet Cards™ can easily be matched with the proper garment if it falls off the hanger. The first plastic sleeve 130 is predominately transparent and can be treated and/or tinted so as to prevent the note card 150 from yellowing from oxidation or sunlight.

The first sleeve 130 shown in FIG. 3 has a first side 131 and a second side 132 directly across from the first side 131. The third side 133 is directly across from a fourth side 134. The first side 131 has an opening configured to allow a note card 150 to slide in and out. The second side 132 is at least partially affixed to the body 105 or in the alternative completely affixed to the body 105 so that the sleeve is secured to the body 105. The third side 133 and fourth side 134 are attached to the body 105 at the corners and have slots positioned therein. note card 150 is designed with side tabs 155 and a top tab 160.

The note card 150 designed with side tabs 155 can be pinched together, slide into the first sleeve and when the side tabs 155 are fit within the slots 170, released so that the side tabs 155 retain the note card 150 in a slidable configuration in the first sleeve. That is, with the side tabs 155 positioned within the slots 170 formed in the third 133 and fourth sides 134, the note card 150 can slide in and out of the first sleeve 130 without falling out of the sleeve. The side tabs 155 are configured so as to retain the card within the first sleeve 130 and are stopped when the contact end portions 152 that are part of sides 133 and 134.

Similarly, the second sleeve 135 shown in FIG. 3 can be configured so that the first side 136 and a second side 137 are directly across from each other and a third side 138 and a fourth side 139 are directly across from one another. The first side 136 may have an opening configured to allow a note card 200 to slide in and out of the second sleeve 135. The second side 137 is at least partially affixed to the body 105 and in the alternative can be fully affixed. The third side 138 and fourth side 139 are attached to the body 105 at the corners so that the first sleeve is fully secured to the body 105 of the device of the present invention. The structure of the second sleeve 135 is configured to fit a note card 200 that is designed with side tabs 210 and a top tab 215. The note card 200 designed with side tabs 210 can be pinched together and the side tabs 210 slid into the second sleeve 135 so that they are positioned within slots 220. Once in position, the note card 200 can be released and the note card 200 can slide up and down in the second sleeve 135 with the side tabs 210 retaining the note card 200 therein. The side tabs 210 are configured so as to retain the card within the second sleeve 135 and are stopped when they come in contact with the end portions 212 that are part of sides 138 and 139. That is, the note cards can travel along the track and be exposed to allow information to be written on the card and once finished the note cards can be slid back into the second sleeve.

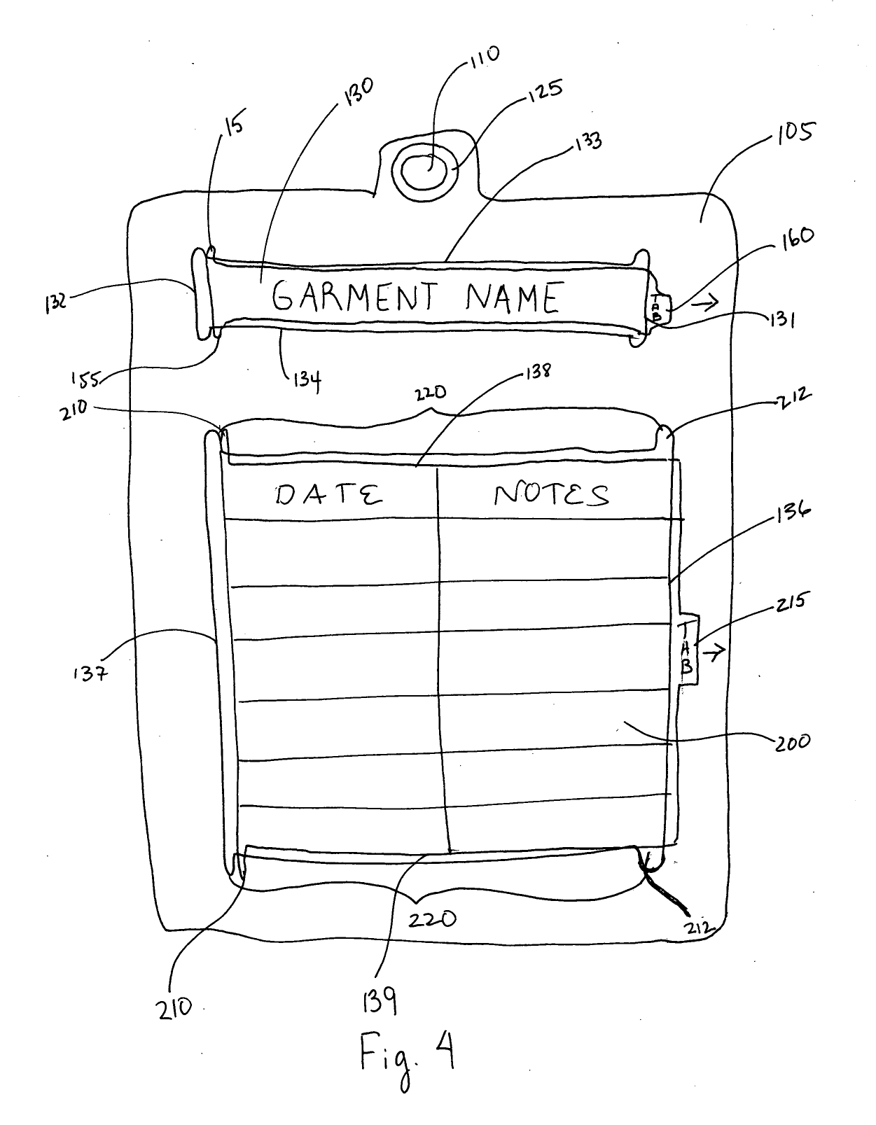

In the alternative embodiment of the present invention, the first sleeve 130 and second sleeve 135 shown in FIG. 3 can be configured to have side tabs located at the top and the bottom of the sleeves instead on the sides. The note cards can also be configured to have a pull-tab located on either or both sides of the note cards to aid in sliding the note cards out of the sleeves. This embodiment is shown in See FIG. 4.

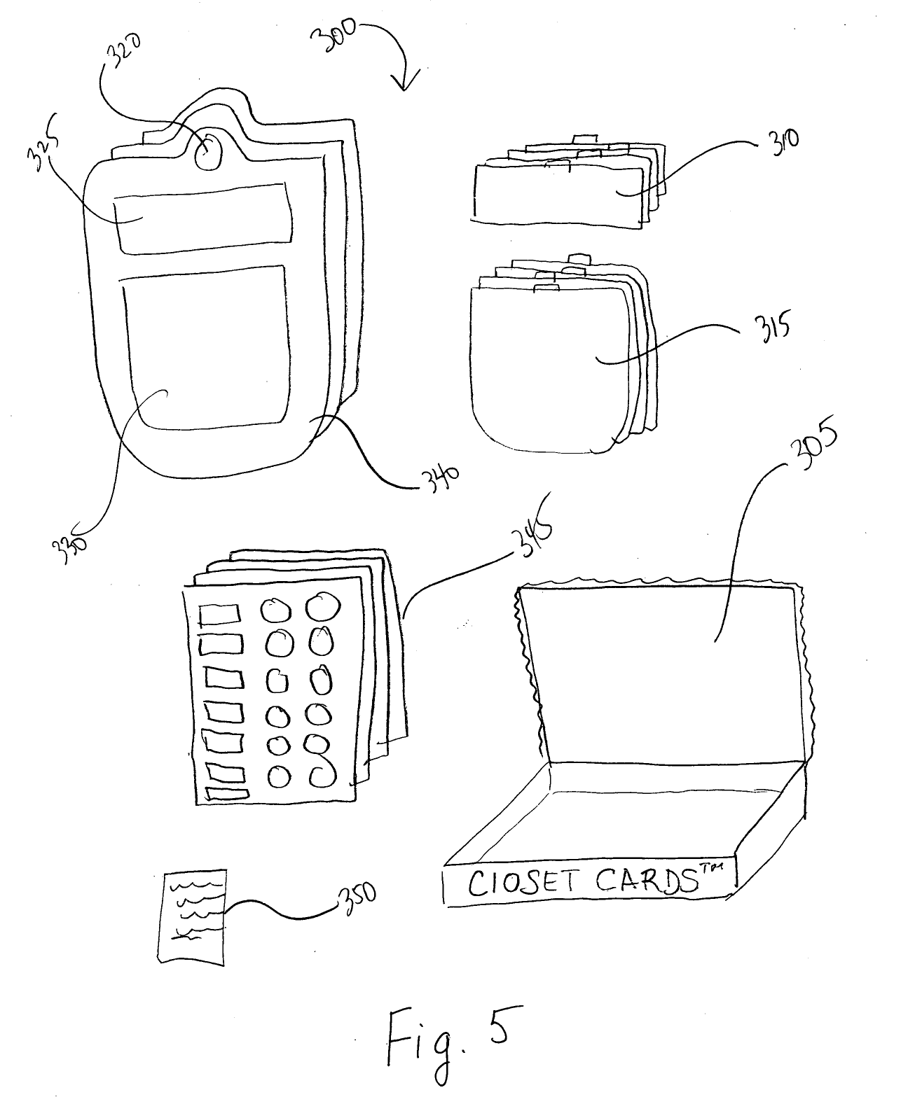

FIG. 5 shows a Closet Cards™ kit 300 containing a holding box 305, a plurality of garment name cards with tabs 310 and a plurality of note cards with tabs 315. The kit will also include a plurality of Closet Cards™ 340 having a hanger hole and a first transparent sleeve 325 configured to fit the name cards and a second transparent sleeve 330 configured to fit the note cards 315. The kit can also be equipped with a colored sticker set 345 that can be used to track the use and cleaning dates of the garments in the closet using a color-coded system. Finally, the kit can include instructions on how the Closet Cards™ system can be used to track the garments in your closet.

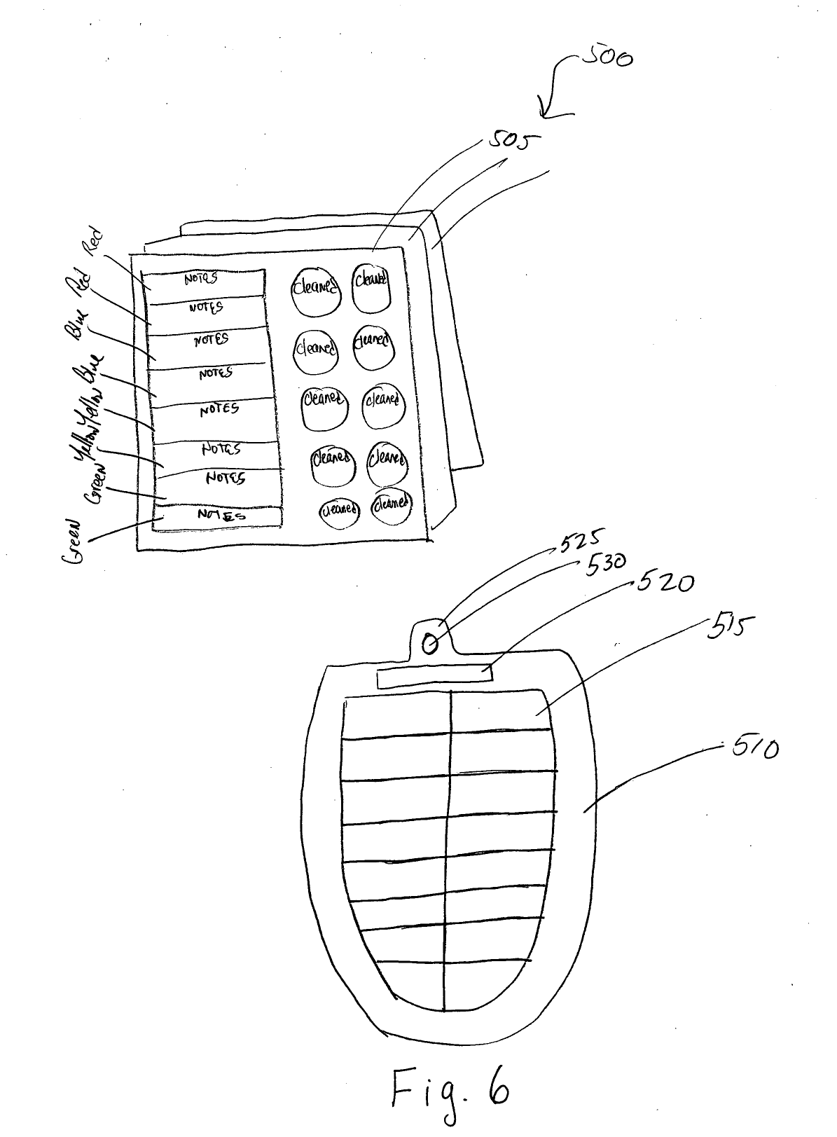

FIG. 6 shows in greater detail the sticker card system 500 of the present invention. A plurality of stickers either preprinted with information that can be used to track a garment or blank stickers is provided. In addition to the colored stickers are specially adapted Closet Card™ 510 having a surface conducible to adhere stickers 515 which can be covered with a transparent sleeve. The Closet Cards™ are equipped with a tab 525 having a hole 530 in it for attaching to a garment hanger. The colored sticker system can be used to indicate when a garment was worn and/or to which particular client.

The stickers can be stored on a hanger card that fits on either a spare hanger, clips onto the pole that holds the hangers, or is affixed to the wall in the front near the clothes so that they are easily accessible. The hanger card will also have a space next to each colored sticker to indicate what each color represents. For example, if red means client A, when a red sticker is placed on the Closet Card™ associated with a particular garment this would indicate that the garment was worn to client A. The stickers can be made of paper so that a date can be inscribed on the stickers so as to indicate when it was worn. In the alternative, the order of the colors on a note card associated with a particular garment can be used to show the order in which the garment was last worn. In other words, if there are four colors between two red stickers it means that there was some time between when this garment was worn to that client represented by the red sticker. This system can be quick and easy and require little to no writing thereby further reducing the risk of marks on the garments.

Additional embodiments of the Closet Card™ system of the present invention can use similar different indicator systems such as bar codes, RFID tags, colored markers, etc. and are deemed to fall within the inventive intent of the present invention. The Closet Cards™ of the present invention can take various different shapes and sizes as long as they fit within the garment and do not have exposed edges that can accidentally damage the garment. Some of the different shapes can resemble clothing items, such as blouses, shirt and tie combos, pants, and suits; animals, such as kangaroos, penguins, horses, giraffes, elephants, and squires; landmarks, such as the Empire State Building, Statute of Liberty, and Eiffel Tower; and company logos.

The present invention can be manufactured with a closed pouch and a slit made above below or alongside the pouch in order to put the note cards therein. The slit in the heavy stock made either below the top portion of the transparent window, above the top portion of the transparent window, or alongside the transparent window functions to allow access to the pouch. The slit in the front stock made below the top of the transparent window allows direct access to the transparent pouch formed from the transparent material. The note cards are configured to fit within the pouch and can be viewed through the transparent window of the pouch. The note cards are removed from the pouch through the slit in order to place additional notes thereon. Once the notes are completed, the note cards can be slid back into the pouch and viewed through the transparent window. Having the slit above the transparent pouch assures that the pouch would not tear away from the Closet Cards™ accidentally.

In an alternative embodiment of the present invention the pouch can be made from transparent material on both sides so that both sides of the note cards placed therein can be seen. This allows a first side of the note cards to be filled out and when completed, the Closet Cards™ can be taken off of the hanger and turned around so that the second side of the note card can be used and viewed through the second side of the transparent pouch.

Similarly, the Closet Cards™ of the present invention can be manufactured with the slit along side the transparent pouch in the stock material. As stated above, the slit can be made directly in the transparent material or along either side or below the top of the transparent material that provides access to the pouch. In the embodiments where the slit is made in the transparent material, the slit must be reinforced in order to prevent accidental ripping of the transparent material.

This design of the present invention can be made from two pieces of heavy stock as described in the other embodiments above having windows cut in either one or both pieces of the stock. On the inside of the heavy stock, transparent material can be glued on all four sides around the window(s) to assure that the transparent material stays in place. In the embodiments that have two-sided windows, both pieces of heavy stock have windows cut in the exact positions so that when the two pieces are glued together the windows align. Once in position, the two pieces of heavy stock can then be glued or fastened together to create pouches in which the note cards can be placed. Slits are made in the heavy stock just below the top of the glued transparent window so that the note cards can easily be inserted and removed from the pouches. As with the other embodiments, the note cards can be equipped with tabs that allow for easy grasping of the note cards.

Yet another embodiment of the present invention can be made form a single sheet of material having at least one, preferably two windows cut therein. The cut out windows are positioned on the single sheet so that when the single sheet is folded on itself like a book to make the device of the present invention they are equidistant from the left and right edges of the folded material. To facilitate folding of the single sheet during manufacturing a crease or a row of dimples can be made at the place of the fold thereby aiding in a clean fold.

The transparent material making up the window can be affixed to cover the cut out window prior to folding so that when folded the windows are in place. The edges of the transparent material can be glued, paper-welded, or faceted to either the inside or outside face of the Closet Cards™ of the present invention. Attaching the transparent material to the stock can be used to form the pocket in which the note cards can be placed or additional welding can be done along the outside rims of the glued transparent pouch in order to provide additional support for the pouch. The additional support would ensure that the note card would not cause the transparent material to detach when it is placed back into the pocket over time. Different methods of achieving this configuration can be contemplated and are herein considered to fall with the scope of the present invention.

Once the single sheet is folded to create the Closet Cards™ of the present invention, the three open edges, namely the top edge, bottom edge and side edge are sealed using glue, faceting, paper-welding, or any other mechanism that can be used to adhere the front and back faces together as a single unit. Of course keeping with the main principle of the present invention any mechanism used to adhere the faces together must not leave trace edges exposed so as to cause damage to clothes being hung on the hanger used in connection with the Closet Cards™.

Slits are formed in the stock either above or to the side of the pockets that allow the note cards of the present invention to be slide and out of the pockets when in use. The slits are configured to fit the note cards and can be made after the device is in final form with the transparent windows installed or in the alternative all cut out and slits can be made in the single stock prior to folding. The sequence of events used to manufacture the present invention, such as when in the process the cutouts and sealing is done, is a matter of manufacturing preference and does not deviate from the spirit of the present invention.

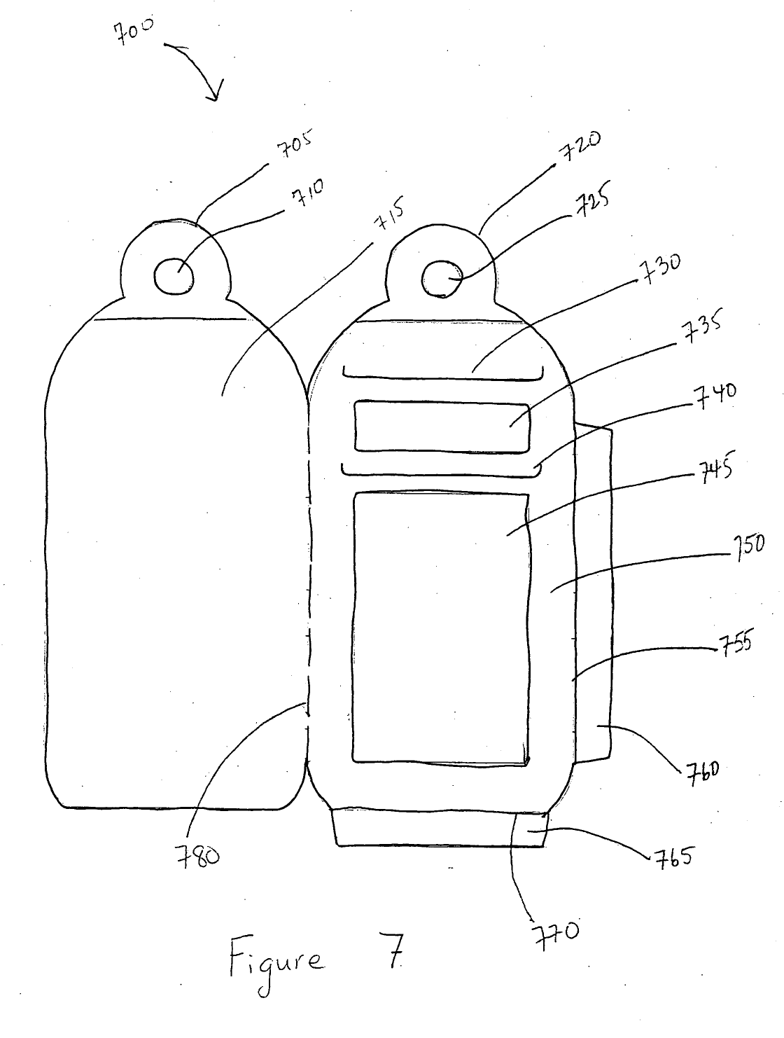

FIG. 7 is a prospective front view of the foldable version of the Closet Card™ of the present invention as discussed above. In this figure, a single sheet foldable closet card (700) of the present invention is shown as a flat sheet of stock having a front face (750) and a back face (715) which are mirror images of each other and are configured to fold on top of each other as a greeting card along the a creased line (780). On the top portion (720) of the Closet Card™ is a port (725) configured to allow a hanger to slip within and attach the Closet Card™ to the garment hanger.

The Closet Card™ is configured to have a first viewing window (735) and a second viewing window (745) both windows are cut into the front (750) part of the Closet Card™ and are covered with a transparent material such as clear plastic or cellophane. Above the first (735) and second windows (745) are slits (730) and (740). These slits are configured to allow cards describing the garment and a place to write dates and notes, to be inserted into the slits so that the written date/notes appear in the first and second viewing windows (735) and (745). This protects the garment from getting any ink or marker transferred to the garment from the cards and is a very important feature of the present invention.

The Closet Card™ shown in FIG. 7 is closed on crease (780) and flap (760) is then closed on crease (755) and flap (765) is closed on crease (770) to secure the front (750) to the back (715). These can be glued or paper welded to secure the device as one piece. Once this is done port (710) in the upper portion (705) of back (715) aligns with port (725) in upper portion (720) of the front (750) to act as one port. This reinforces the port so that the port will not tare or ripe if the Closet Card™ is accidentally pulled on. To further secure the device stays in the closed position to retain the garment cards and noted cards in windowed pouches (735) and (745) the device can be glued, paper welded or sewn close.

In the alternative the Closet Cards™ of the present invention can be made using two pieces of stock. Each piece is approximately the same size and can eventually be fixed together to form the device of the present invention. In the model in which a window is in only one side of the present invention, windows are cut in only the front side of the heavy stock and the backside is a full sheet of heavy stock. Once the windows are cut into the front piece of heavy stock, they are covered with transparent material on the inside as described above. The two pieces of stock are then placed in a front on back arrangement and are either glued, paper-welded or faceted together to make the final Closet Cards™. The front piece of heavy stock will have a slot cut at the top or to the side of the glued transparent window to allow access to the pouch from the outside. As with the mechanism above, the attaching of the transparent material can be used to form the pocket in which the note cards can be placed or additional welding can be done in order to provide additional support.

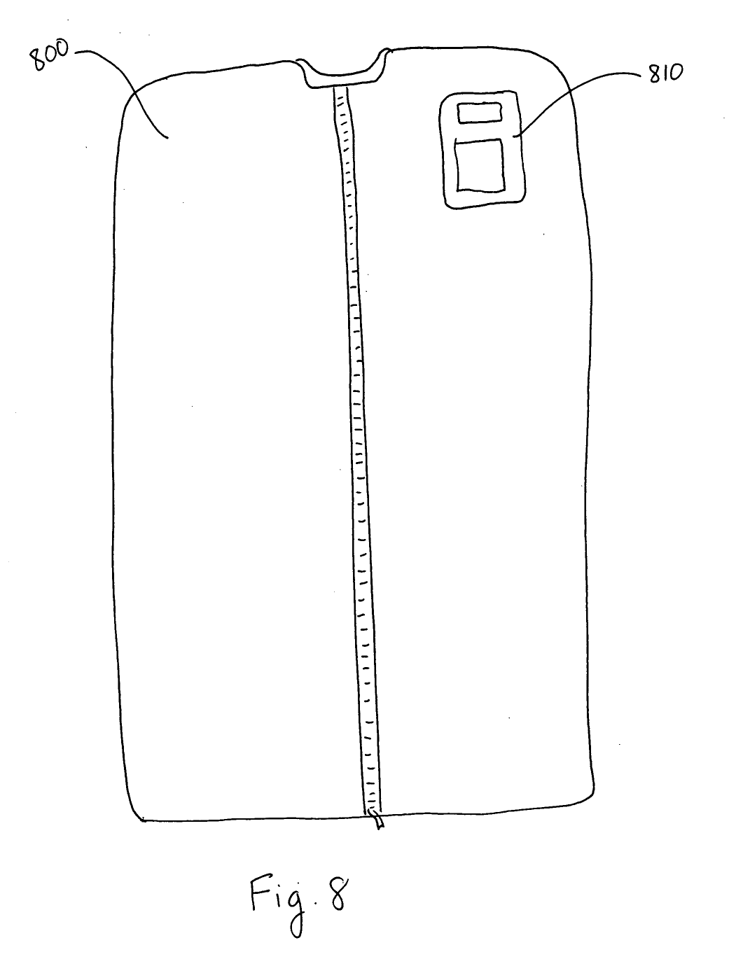

FIG. 8 shows a garment bag (800) having one of the Closet Cards™ (810) affixed to the upper portion of the garment bag. The Closet Cards™ (810) can be affixed in the upper right or left hand corner of the garment bag (800) or in the alternative in the pocket area of the bag. This can be used for high-end gowns, bridal gowns, tuxedos, and glamour and expensive designer wear. In essence, several garments bags can be used in a closet so as to further protect the garments from dust, light, yellowing, and odors/mildew. A kit can be sold with several garment bags having Closet Cards™ affixed there to and extra note cards.

In all of the above embodiments of the present invention, the note cards can be blank or can have permanent lines/columns drawn on them so as to provide a space for information concerning the place and date last worn and the date cleaned. A kit including several Closet Cards™ and notes cards in the same or different colors, shapes, or designs is also provided in the present invention. Replacement cards can be purchased separately and can be slide into the transparent plastic sleeves/pouches so that the ink/pencil used to take notes is shielded from the garment itself.

As stated above, the Closet Cards™ can be made from thick stock paper, laminated paper, plastic, thin cedar planks, leather, suede, material covered stock and combinations thereof. The Closet Cards™ can be crafted so that they are reversible and both sides of the inserted note cards can be seen through the transparent windows that can be seen from each side of the Closet Cards™. This way once one side of the note card is completed, the complete closet hanger can be removed from the hanger and reversed so that the clean side of the note card can be viewed from the same direction. The two sided note cards will have some marking on the body to indicate the first side and the second side. In order not slow down the user when looking for a garment, it is preferred that all of the closet hangers be oriented in the same direction.

Any configuration of the Closet Cards™ of the present invention discussed above can be made in different shapes as well as sizes in order to accommodate different needs and uses of the user. For example, in the figures discussed above the first sleeve or pouch can be used to include a card that identifies the garment on the hanger in which it is placed. The first sleeve can be about 4 inches wide by about 1.25 inches in height and can be located at the top portion of the Closet Cards™. Spaced below it would be the second sleeve/pocket that is designed to hold the second note card in which the actual data about when and where the garment was worn and when it was cleaned is recorded. This sleeve/pocket can be designed to fit a note card about 4 inches wide and about 5.5 inches in height. The overall size of the Closet Cards™ could be about 8 inches in height and about 5 inches wide, where the note cards would be slightly smaller than the sleeves so that they can easily fit in each pocket. The second sleeve can be designed so as to fit more than one card in a back-to-back configuration so that when one is finished a second one is readily available.

The present invention is also directed to a method for maintaining and tracking garments of a wardrobe using the Closet Cards™ system of the present invention.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A clothing tracking device comprising,
a body having an opening in said body, said opening configured and positioned on said body such that a garment hanger fits within said opening positioning so as to facilitate hanging of said clothing tracking device on a clothes hanger in an orientation so that information on said body is readable and said body does not cause damage to a garment hung on said hanger;
said body having at least one windowed pocket configured to hold at least one note card, said windowed pocket being cut out of said body and covered by a transparent material to form the window, said at least one windowed pocket having three sides completely affixed to said body and one side at least partially unfixed to said body such that said at least one note card can be inserted therein; and
said at least one note card having a recording area adapted for recording date, event, and notes, said at least one note card configured to show said recorded date, event and notes through said transparent material when placed in said at least one windowed pocket.

2. The clothing tracking device according to claim 1 wherein said body is made from a semi rigid to rigid sheet material, said material selected from the group consisting of stock, plastic, paper, material covered paper, compressed cardboard, man-made material, and combinations thereof.

3. The clothing tracking device according to claim 2 comprising at least two windowed pockets in said body and at least two note cards.

4. The clothing tracking device according to claim 3 wherein said at least two windowed pockets are positioned one below each other with said first windowed pocket arranged at the top of said body.

5. The clothing tracking device according to claim 1 wherein said at least one note card is configured to have at least one tab formed in said upper edge so as to provide easy access to said note card when placed in said at least one windowed pocket.

6. The clothing tracking device according to claim 1 wherein said body is configured in a shape selected from the group consisting of parallelepiped, square, rectangular, oval, semi-circular, circular, animal-shaped, dress-shaped, suit jacket-shaped, shirt-shaped, skirt shaped, blouse-shaped, women's silhouette-shaped, men's silhouette-shaped, and combinations thereof.

7. The clothing tracking device according to claim 6 wherein said at least one note card are pre-printed with lines and category topics on at least one side of said at least one note card.

8. The clothing tracking device according to claim 7 wherein said opening is positioned on the side of said windowed pocket and said at least one note card inserted therein has at least one tab that is configured to extend from said windowed pocket so as to allow easy access to said note card.

9. A closet organizing kit comprising;
a plurality of clothing tracking devices of claim 1,
a plurality of note cards;
colored stickers having a writing surface on one side and an adhesive material on the other side; and
a master closet card configured to attach to a hanger having a covered writing surface for notes about the entire closet.

10. A clothing tracking device comprising,
a substantially rectangular body made of a rigid sheet material having a reinforced opening in said rigid sheet material, said opening configured and positioned on said rigid sheet to permit a garment hanger to fit within and cause said substantially rectangular body to lie in such a way as not to interfere with or cause damage to a garment to be hung on said hanger;
at least one pocket formed from a transparent material on said rigid sheet material, said pockets having at least three sides that are fixed to said rigid sheet material to form said pocket;
a note card configured to fit within said pocket having a tab configured to extend outside of said pockets so as to guide said note card when slide in and out of said pocket, said note card having a recording area adapted for recording date, event, and remarks of an occasion wherein said clothing was worn.

11. The clothing tracking device according to claim 10 wherein said rigid sheet material is selected from the group consisting of plastic, paper, material covered paper, compressed cardboard, man-made material, upholstered stock, fabric and combinations thereof.

12. A closet organizing kit comprising;
a plurality of clothing tracking devices of claim 10,
additional note cards;
colored stickers having a writing surface on one side and an adhesive material on the other side; and
a master closet card configured to attach to a hanger having a writing surface for notes about the entire closet.

13. A clothing tracking device comprising,
a body, having a reinforced opening in said rigid sheet material, said opening configured and positioned on said rigid sheet to permit a garment hanger to fit within and cause said substantially rectangular body to lie in such a way as not to interfere with or cause damage to a garment hung on said hanger;
said body further comprising at least one window cut out, said window cut out positioned so that when said body is folded on itself to produce a front portion and a back portion, said window cut out being positioned substantially equidistant from a right and a left edge of said body when folded;
a transparent material attached to said body such that it covers said at least one window cut out;
at least one pouch formed in said body configured to encompass at least a portion of said at least one window cut out;
a note card configured to fit within said pouch; and
at least one slit in said body configured to allow said note cards to slid in and out of said pouch.

14. The clothing-tracking device of claim 13 wherein said at least one slit is positioned either above or to the side of said pouch.

15. The clothing-tracking device of claim 13 wherein said recording area is configured to record date, event, and remarks of an occasion wherein said clothing was worn.

16. The clothing tracking device according to claim 13 comprising at least two windowed pockets in said body and at least two note cards.

17. A garment bag having said clothing-tracking device of claim 1 incorporated therein.

18. A garment bag having said clothing-tracking device of claim 10 incorporated therein.

19. A garment bag having said clothing-tracking device of claim 13 incorporated therein.

20. The clothing tracking device according to claim 13 wherein said body is configured in a shape selected from the group consisting of parallelepiped, square, rectangular, oval, semi-circular, circular, animal-shaped, dress-shaped, suit jacket-shaped, shirt-shaped, skirt shaped, blouse-shaped, women's silhouette-shaped, men's silhouette-shaped, and combinations thereof.

21. A method of tracking the purchase and wearing of clothing comprising;
(a) affixing a clothing-tracking device of claim 1 to a hanger having a particular garment;
(b) notating the date, event, and pairing of the garment on said hanger on said note card associated with said garment; and
(c) repeating steps (a) and (b) as needed.
